(19) United States
(12) Patent Application Publication
(10) Pub. No.: US 2013/0317957 A1
(43) Pub. Date: Nov. 28, 2013

(54) Location Based Determination of Payroll Tax Withholding

(71) Applicant: TEKNON CORPORATION DBA SYMMETRY SOFTWARE, INC, Scottsdale, AZ (US)

(72) Inventors: Tom Reahard, Scottdale, AZ (US); William Long, Phoenix, AZ (US); Martin Sladok, Scottsdale, AZ (US)

(73) Assignee: Teknon Corporation DBA Symmetry Software, Inc., Scottsdale, AZ (US)

(21) Appl. No.: 13/786,587

(22) Filed: Mar. 6, 2013

Related U.S. Application Data
(60) Provisional application No. 61/652,105, filed on May 25, 2012.

(51) Int. Cl. G06Q 40/00

(52) U.S. Cl. CPC G06Q 40/103
USPC 705/31

(57) ABSTRACT

Determining a payroll tax withholding can comprise receiving, at a tax calculation system, a residential address and an employment address of an employee, determining latitude and longitude coordinates of the residential and employment addresses, retrieving a plurality of residential geocodes associated with the latitude and longitude coordinates of the residential address, wherein the plurality of residential geocodes include tax boundaries in which the location of the residential address resides, retrieving a plurality of employment geocodes associated with the latitude and longitude coordinates of the employment address, wherein the plurality of employment geocodes include tax boundaries in which the location of the employment address resides, and retrieving applicable tax rates corresponding to the plurality of residential geocodes and the plurality of employment geocodes from a tax rate database. The applicable tax rates include at least one of include state, county, city, school district, and municipal tax codes.

### PRIORITY CLAIM

This application is a non-provisional of, and claims the benefit of, U.S. Provisional Application No. 61/652,105, entitled, “LOCATION BASED DETERMINATION OF PAYROLL TAX WITHHOLDING,” which was filed on May 25, 2012, which is hereby incorporated by reference for any purpose in its entirety.

### FIELD OF THE INVENTION

The disclosure relates generally to calculating payroll tax withholding based on location, and in particular, to a system and method for facilitating the determination of the taxable authorities, along with calculating and accounting payroll taxes.

### BACKGROUND

The calculation of payroll tax withholding is generally the same for most businesses. Initially, an employee's gross pay is determined. Next, allowances are deducted from the gross pay. The allowances are determined by multiplying the number of withholding allowances the employee has claimed on his W4 form by the amount of one allowance for his filing status and the length of the pay period. This amount is subtracted from the gross wages. In addition, any tax deductions are subtracted, such as contributions to a tax-deferred retirement plan. The remainder is the employee's federal taxable income.

In various embodiments, the third step includes calculating the federal income tax to be withheld. The federal income tax is computed using a series of tax brackets with percentages that increase as income goes up. The fourth step can include determining any state or local income tax to be withheld. Each state has its own formula and rates, which must be determined for an accurate withholding, in addition, other local income taxes have to also be determined and applied. In various embodiments, the local income taxes may include boundaries such as county, city, school district, and the like. After the federal, state, and local taxes are withheld, remaining taxes of Social Security and Medicare taxes are deducted from the paycheck. Social security and Medicare taxes are flat rate taxes with known limitations.

As demonstrated by the general outline of calculating payroll tax withholding and net employee pay, the process can be fairly straight-forward. Most of the withholding tax rates and amounts are known. However, state and local taxes are more specific and are not broadly defined.

Some tax engines estimate withholding tax based on the zip codes of an employee's work and residence locations. This approach typically is sufficient for estimating state taxes. However, local tax boundaries may not align with zip code boundaries or can be more specific within a zip code. Such a discrepancy can result in decreased accuracy of estimated withholding taxes. Accordingly, a system and method for more accurately determining local taxes for payroll tax withholding is needed.

### SUMMARY

In accordance with various methods, determining a payroll tax withholding can comprise receiving, at a tax calculation system, a residential address and an employment address of an employee, parsing the residential address and the employment address of the employee, determining latitude and longitude coordinates of the residential address and latitude and longitude coordinates of the employment address and retrieving a plurality of residential geocodes associated with the latitude and longitude coordinates of the residential address. The plurality of residential geocodes can include tax boundaries in which the location of the residential address resides. The method can also comprise retrieving a plurality of employment geocodes associated with the latitude and longitude coordinates of the employment address, where the plurality of employment geocodes include tax boundaries in which the location of the employment address resides, and retrieving applicable tax rates corresponding to the plurality of residential geocodes and the plurality of employment geocodes from a tax rate database. The applicable tax rates can include at least one of state, county, city, school district, and municipal tax codes.

### BRIEF DESCRIPTION OF THE DRAWINGS

These and other features, aspects and advantages of disclosure may be best understood by reference to the following description taken in conjunction with the accompanying drawings:

FIG. 1 illustrates an exemplary flowchart of calculating payroll tax withholding in accordance with various embodiments;

FIG. 2 illustrates an exemplary flowchart of calculating payroll tax withholding in accordance with various embodiments; and

FIG. 3 is a block diagram of an exemplary computer system used for implementing the various embodiments.

### DETAILED DESCRIPTION

The disclosure may be described herein in terms of functional block components, screen shots, optional selections and various processing steps. It should be appreciated that such functional blocks may be realized by any number of hardware and/or software components configured to perform the specified functions.

The detailed description of exemplary embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

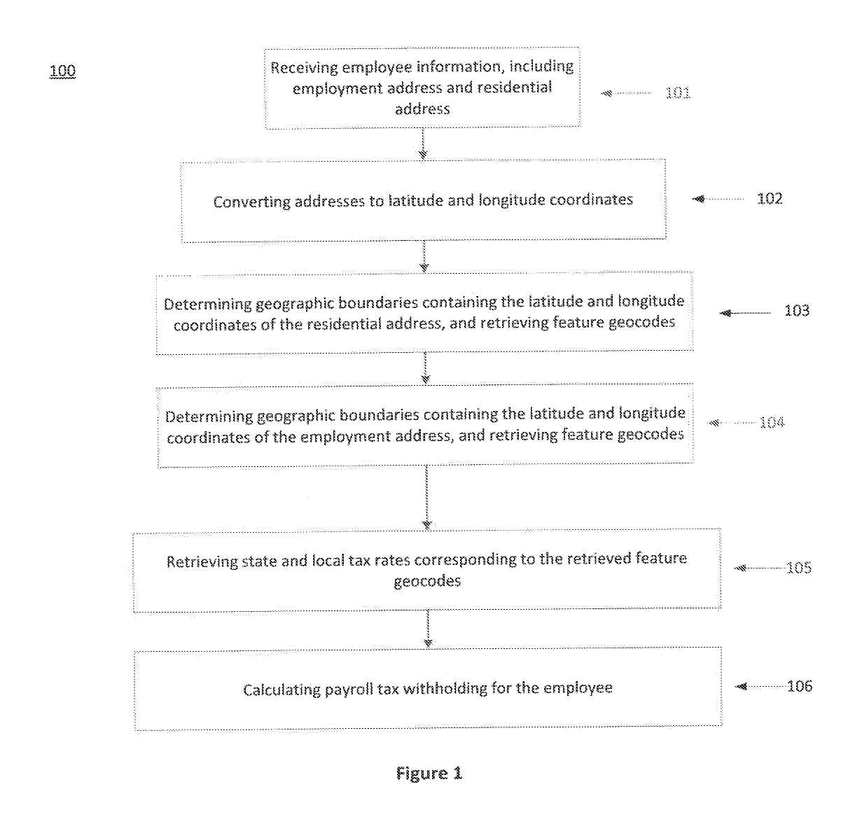

In accordance with various embodiments, a payroll tax system can be configured to calculate state and local payroll tax withholding using an employee's work address and the employee's residential address. Unlike some prior art systems and methods, the disclosed system utilizes latitude and longitude coordinates rather than zip codes, resulting in more accurate tax withholding calculations. This is beneficial because local tax boundaries may not align with zip code boundaries or can be more specific within a zip code. In accordance with various embodiments and with reference to FIG. 1, a tax calculation method of determining a payroll tax withholding 100 can comprise receiving a residential address and an employment address of an employee 101, and parsing the residential address and the employment address of the employee if desired. Further, the tax calculation method 100 can determine latitude and longitude coordinates of the residential address and latitude and longitude coordinates of the employment address 102. The tax calculation method 100 can also retrieve a plurality of residential geocodes associated with the latitude and longitude coordinates of the residential address 103, where the plurality of residential geocodes include tax boundaries in which the location of the residential address resides. The various methods further comprise retrieving a plurality of employment geocodes associated with the latitude and longitude coordinates of the employment address 104, where the plurality of employment geocodes include tax boundaries in which the location of the employment address resides. The tax calculation method 100 can retrieve applicable tax rates corresponding to the plurality of residential geocodes and the plurality of employment geocodes from a tax rate database 105. The tax calculation method 100 may then calculate the payroll tax withholding for the employee 106.

In various exemplary embodiments, a user can input address information for an employee's work location and residential location to the payroll tax system 100. The user may also provide an employee's gross pay, pay frequency, filing status, state of residence, the calculation date, or any combination thereof. In various embodiments, other tax related inputs can also be provided to the payroll tax system 100, such as voluntary deductions, 401(k) contributions, health savings account contributions, insurance payments, wage garnishments, and the like. Depending on the state of residence and corresponding state tax code, additional information may be requested for calculating the payroll tax withholding. For example, an employee selecting Colorado can be asked if the employee resides in a Political Subdivision. Another example includes an employee selecting California can be asked to apply California state disability insurance (SDI) tax, in various embodiments, each state can have its own input parameters.

The user may provide the information at a remote terminal or at a local computer-based system. The address information can be used to determine latitude and longitude coordinates for both the work address and the residential address. Both the work and residential addresses are provided in order to determine potential tax reciprocities that may exist. The coordinate determination may be processed by a third party, from a software program, or from a database. The third party may be, for example, a website such as Bing, Google, Melissa Data, www.geocoder.us, and other similar websites.

In various embodiments, latitude and longitude coordinates can be provided to the tax calculation system directly, instead of being determined from a physical address. For example, an employee's residential and/or work coordinates can be provided to the tax calculation system from a device with a global positioning system (GPS), such as a smart phone. Similarly, a user can provide location coordinates based on a reading from a GPS device instead of providing an address.

After the system receives the latitude and longitude coordinates, a graphical information system (GIS) shapefile database can be searched using the latitude and longitude coordinates. The GIS shapefile database includes various features, including geographic boundaries in which the location of the latitude and longitude coordinates reside, referred to as feature geocodes. The database query returns feature geocodes for the various geographic boundaries in which the location of the address resides. Geocodes correspond to various geographic features. For example, the geographic feature can include cities, townships, unincorporated districts, schools, and the like.

In various embodiments, the geocodes are Geographic Names information System (GNIS) codes from the GNIS. The Geographic Names Information System (GNIS) includes geographic names for all known places, features, and areas in the Unites States that are identified by a proper name. In various embodiments each feature can be located by state, county, and geographic coordinates; and can be referenced to the appropriate 1:24,000-scale U.S. Geological Survey (USGS) topographic map on which it is shown.

The GNIS Feature Names Data Base contains records on almost 2 million geographic features in the United States—from populated places, schools, reservoirs, and parks, to streams, valleys, springs, and ridges. The data base is being compiled in two phases. The first phase is complete for all States and areas under U.S. jurisdiction and included the collection of most feature names found on the 1:24,000-scale maps published by the USGS, as well as names on National Ocean Service charts, U.S. Forest Service maps, and in data files of the Army Corps of Engineers, the Federal Aviation Administration, and the Federal Communications Commission. The second phase of compilation is on-going, and involves the collection of current and historical names from official State publications and local materials.

Standard reports and digital data sets are available by State and include all geographic name records currently in the GNIS Feature Names Data Base for the individual State or territory. The entries can be sorted alphabetically by feature name. Each entry can include the official name of the feature; the feature type; the status of the name as viewed by the U.S. Board on Geographic Names; the State and county in which the feature is located; and geographic coordinates in degrees, minutes, and seconds that locate the approximate center of an areal feature or the mouth of a linear feature. Geographic coordinates that locate the source or heading of linear features are also given, as is the name of the 1:24,000-scale USGS topographic map on which the feature is portrayed. If available, the elevation in feet can be provided.

In accordance with various embodiments, a tax engine system can receive the feature geocodes. In one embodiment, the tax engine system is a Symmetry Software® product, such as Symmetry Tax Engine®. The tax engine system can comprise a tax rate database having a feature geocode key field. The tax engine system uses the feature geocodes as the database key to retrieve the corresponding tax rates. The retrieved tax rates can be implemented to calculate the applicable state and local withholding taxes to the employee. In various embodiments, the applicable tax rates can include a state tax, a county tax, a city tax, a school district tax, a municipal tax or any combination thereof. In various embodiments, the payroll tax withholding for the employee is calculated based on the residential address, the employment address, and the applicable tax rates. The employee's net pay after substrating the payroll tax withholding from the gross pay can be displayed to the user.

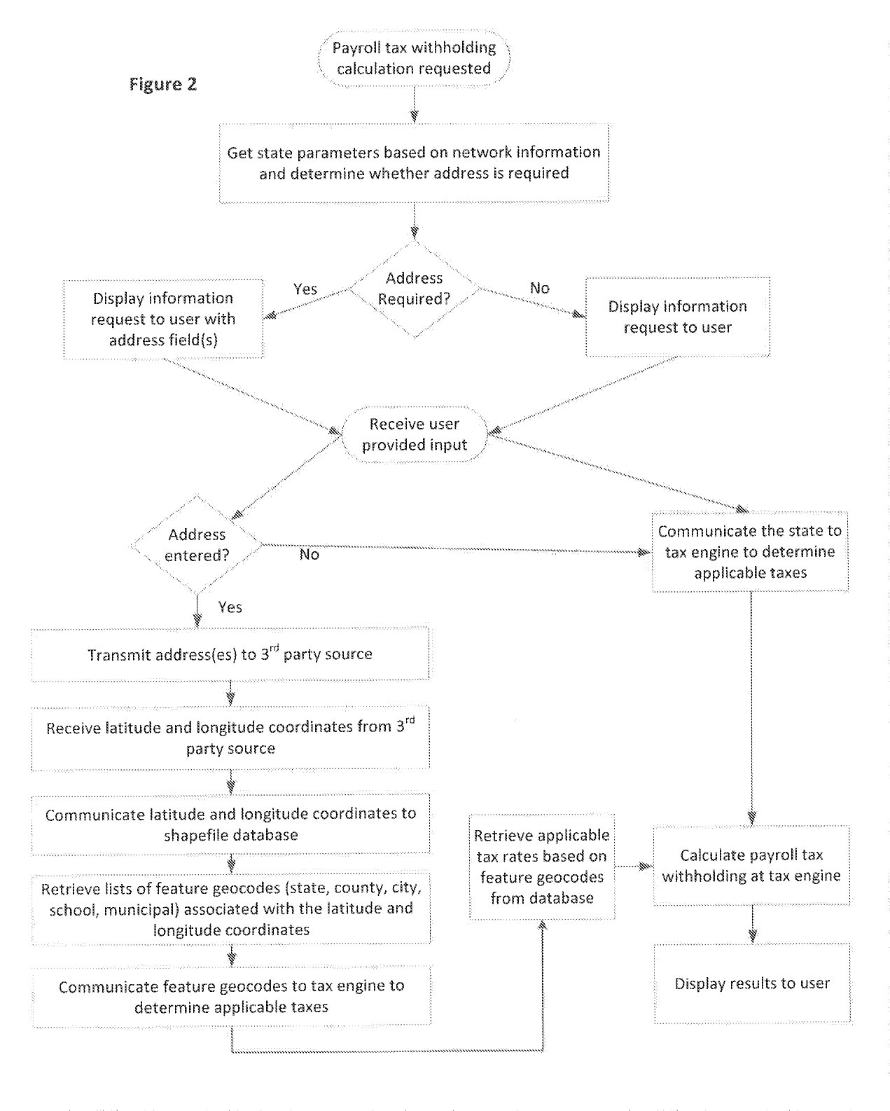

In accordance with various embodiments and with reference to FIG. 2, a more detailed process is illustrated for communications between the tax engine system and the user. In various embodiments, the state of residence and/or state of employment can be determined from the internet protocol address if a remote terminal is being used. Furthermore, in various embodiments, an employee address may not be provided. In such embodiments, the payroll tax withholding can be calculated without accounting for local taxes.

The various embodiments as described herein can be implemented as a network-based system or as a local system. The network-based system can comprise a user providing the employee information from a remote terminal and communicating to a server over the interne. The tax engine system and databases may be operating on one or more servers, and various third party communications may be involved in the calculation of the employee payroll tax withholding. Furthermore, the present system or any part(s) or function(s) thereof may be implemented using hardware, software or a combination thereof and may be implemented in one or more computer systems or other processing systems. However, the manipulations performed by embodiments were often referred to in terms, such as matching, determining, or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

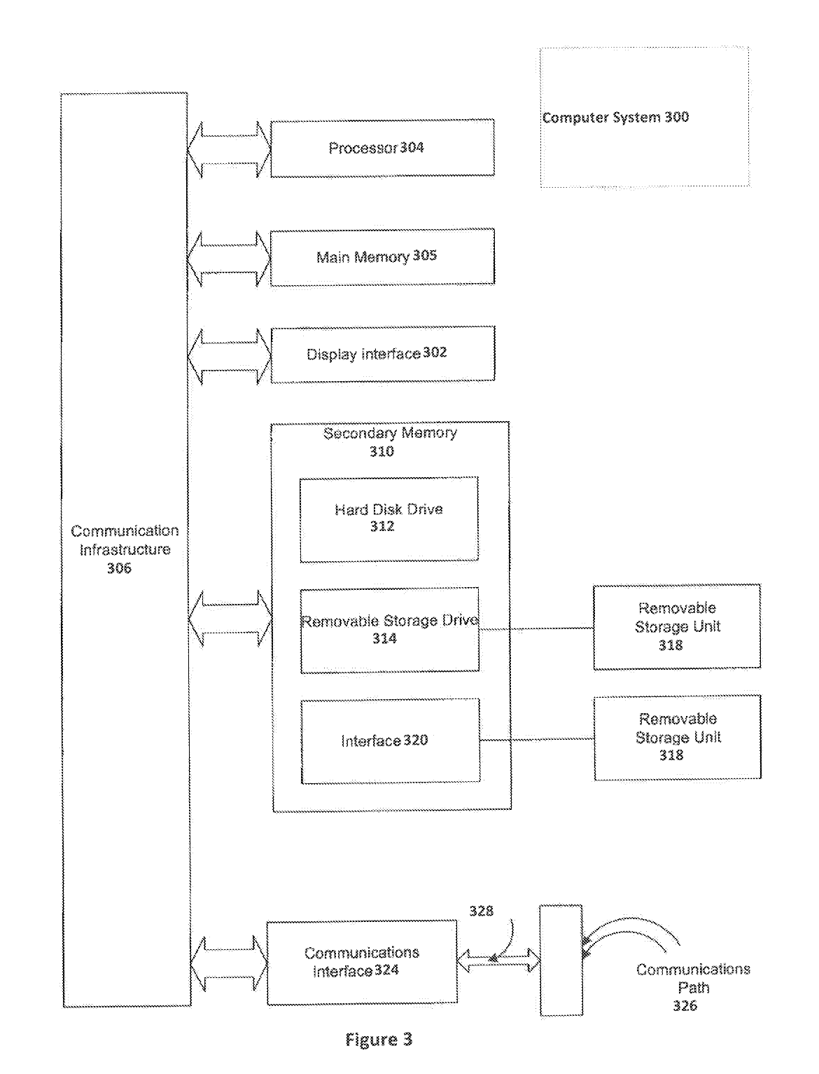

In fact, in various embodiments, the embodiments are directed toward one or more computer systems capable of carrying out the functionality described herein. An example of a computer system 300 is shown in FIG. 3.

The computer system 300 includes one or more processors, such as processor 304. The processor 304 is connected to a communication infrastructure 306 (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures.

Computer system 300 can include a display interface 302 that forwards graphics, text, and other data from the communication infrastructure 306 (or from a frame buffer not shown) for display on a display unit.

Computer system 300 also includes a main memory 305, such as for example random access memory (RAM), and may also include a secondary memory 310. The secondary memory 310 may include, for example, a hard disk drive 312 and/or a removable storage drive 314, representing a floppy disk drive, a magnetic tape drive, an optical disk drive, etc. The removable storage drive 314 reads from and/or writes to a removable storage unit 318 in a well known manner. Removable storage unit 318 represents a floppy disk, magnetic tape, optical disk, etc. which is read by and written to by removable storage drive 314. As will be appreciated, the removable storage unit 318 includes a computer usable storage medium having stored therein computer software and/or data.

In alternative embodiments, secondary memory 310 may include other similar devices for allowing computer programs or other instructions to be loaded into computer system 300. Such devices may include, for example, a removable storage unit 318 and an interface 320. Examples of such may include a program cartridge and cartridge interface (such as that found in video carne devices), a removable memory chip (such as an erasable programmable read only memory (EPROM), or programmable read only memory (PROM)) and associated socket, and other removable storage units 318 and interfaces 320, which allow software and data to be transferred from the removable storage unit 318 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals 328 which may be electronic, electromagnetic, optical or other signals capable of being received by communications interface 324. These signals 328 are provided to communications interface 324 via a communications path (e.g., channel) 326. This channel 326 carries signals 328 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 314 and a hard disk installed in hard disk drive 312. These computer program products provide software to computer system 300.

Computer programs (also referred to as computer control logic) are stored in main memory 305 and/or secondary memory 310. Computer programs may also be received via communications interface 324. Such computer programs, when executed, enable the computer system 300 to perform the features as discussed herein. In particular, the computer programs, when executed, enable the processor 304 to perform the features of various embodiments. Accordingly, such computer programs represent controllers of the computer system 300.

In various embodiments, software may be stored in a computer program product and loaded into computer system 300 using removable storage drive 314, hard drive 312 or communications interface 324. The control logic (software), when executed by the processor 304, causes the processor 304 to perform the functions of various embodiments as described herein.

In various embodiments, hardware components such as application specific integrated circuits (ASICs). Implementation of the hardware state machine so as to perform the functions described herein will be apparent to persons skilled in the relevant art(s).

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, 0S2, UNIX, Linux, Solaris, MacOS, etc) as well as various conventional support software and drivers typically associated with computers.

In various embodiments, the server may include application servers (e.g. WEB SPHERE, WEB LOGIC, JBOSS). In various embodiments, the server may include web servers (e.g. APACHE, IIS, GWS, SUN JAVA SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile/XP/Vista/7, 0S2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of the system may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBiOS, OSI, any tunneling protocol (e.g. iPsec, SSH), or any number of existing or future protocols, if the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Tony, HTTP, The Definitive Guide (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DRL), or various wireless communication methods, see, e.g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited Feb. 27, 2013), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

One skilled in the art will appreciate that system 300 may employ any number of databases in any number of configurations. Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using, a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example, in accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical tiling system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including a header or trailer may be received by a stand alone interaction device configured to add, delete, modify, or augment the data in accordance with the header or trailer. As such, in one embodiment, the header or trailer is not stored on the transaction device along with the associated issue-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such era XML, SOAP, AJAX, WSDL, and UDDI. Web services methods are well known in the art, and are covered in many standard texts. See, e.g., Alex Nghiem, IT Web Services: A Roadmap for the Enterprise (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems fin any of the purposes disclosed herein. WebSphere MQTM (formerly Series) by IBM, Inc, (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any. UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an interne based embodiment, an entirely hardware embodiment, or an embodiment combining aspects of the Internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more,” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

While the principles of the invention have now been made clear in illustrative embodiments, there will be immediately obvious to those skilled in the art many modifications of structure, arrangements, proportions, the elements, materials and components, used in the practice of the invention which are particularly adapted for a specific environment and operating requirements without departing from those principles. These and other changes or modifications are intended to be included within the scope of the invention, as expressed in the following claims.

1. A method for determining a payroll tax withholding, the method comprising:
receiving, by a tax calculation system, a residential address and an employment address of an employee;
parsing, by the tax calculation system, the residential address and the employment address of the employee;
determining, by the tax calculation system, latitude and longitude coordinates of the residential address and latitude and longitude coordinates of the employment address;
retrieving, by the tax calculation system, a plurality of residential geocodes associated with the latitude and longitude coordinates of the residential address, wherein the plurality of residential geocodes include tax boundaries in which the location of the residential address resides;
retrieving, by the tax calculation system, a plurality of employment geocodes associated with the latitude and longitude coordinates of the employment address, wherein the plurality of employment geocodes include tax boundaries in which the location of the employment address resides; and
retrieving, by the tax calculation system, applicable tax rates corresponding to the plurality of residential geocodes and the plurality of employment geocodes from a tax rate database.

2. The method of claim 1, wherein the applicable tax rates include at least one of state, county, city, school district, and municipal tax codes.

3. The method of claim 1, further comprising receiving, by the tax calculation system, employee information, wherein the employee information includes at least one of gross pay, pay frequency, filing status, state of residence, and calculation date.

4. The method of claim 3, further comprising requesting, by the tax calculation system, additional information related to the state of residence for calculating the payroll tax withholding.

5. The method of claim 3, further comprising calculating, by the tax calculation system, the payroll tax withholding for the employee based on the residential address, the employment address, and the applicable tax rates.

6. The method of claim 1, wherein the tax calculation system is an internet-based, online-accessible system.

7. The method of claim 1, wherein the residential address of the employee is received from a remote computer terminal.

8. The method of claim 7, further comprising transmitting a final net pay and withholding tax value to the remote computer terminal for displaying to a user.

9. The method of claim 1, wherein the determining the latitude and longitude coordinates of the residential address comprises receiving the latitude and longitude coordinates of the residential address from an electronic device with a global positioning system.

10. The method of claim 1, wherein the determining the latitude and longitude coordinates of the residential address comprises transmitting the residential address to a third party system, and receiving the latitude and longitude coordinates of the residential address from the third party system.

11. The method of claim 1, wherein the plurality of residential geocodes are Geographic Names Information System (GNIS) codes, and wherein the plurality of employment geocodes are GNIS codes.

12. The method of claim 1, wherein the plurality of residential geocodes and the plurality of employment geocodes are both retrieved from a Shapefile database.

13. The method of claim 1, further comprising determining by the tax calculation system, whether reciprocity exists between tax entities associated with the employment address and the residential address of the employee.

14. An article of manufacture including a non-transitory, tangible computer readable storage medium having instructions stored thereon that, in response to execution by a computer-based system, cause the computer-based system to be capable of performing operations comprising:
receiving, by the computer-based system for determining a payroll tax withholding, a residential address and an employment address of an employee;
parsing, by the computer-based system, the residential address and the employment address of the employee;
determining, by the computer-based system, latitude and longitude coordinates of the residential address and latitude and longitude coordinates of the employment address;
retrieving, by the computer-based system, a plurality of residential geocodes associated with the latitude and longitude coordinates of the residential address, wherein the plurality of residential geocodes include tax boundaries in which the location of the residential address resides;
retrieving, by the computer-based system, a plurality of employment geocodes associated with the latitude and longitude coordinates of the employment address, wherein the plurality of employment geocodes include tax boundaries in which the location of the employment address resides; and
retrieving, by the computer-based system, applicable tax rates corresponding to the plurality of residential geocodes and the plurality of employment geocodes from a tax rate database.

15. A system comprising:
a processor,
a tangible, non-transitory memory configured to communicate with the processor,
the tangible, non-transitory memory having instructions stored thereon that, in response to execution by the processor, cause the processor to be capable of performing operations comprising:
receive, by the processor for determining a payroll tax withholding, a residential address and an employment address of an employee;
parse, by the processor, the residential address and the employment address of the employee;
determine, by the processor, latitude and longitude coordinates of the residential address and latitude and longitude coordinates of the employment address;
retrieve, by the processor, a plurality of residential geocodes associated with the latitude and longitude coordinates of the residential address, wherein the plurality of residential geocodes include tax boundaries in which the location of the residential address resides;
retrieve, by the processor, a plurality of employment geocodes associated with the latitude and longitude coordinates of the employment address, wherein the plurality of employment geocodes include tax boundaries in which the location of the employment address resides; and
retrieve, by the processor applicable tax rates corresponding to the plurality of residential geocodes and the plurality of employment geocodes from a tax rate database.
